(19) United States
(12) Patent Application Publication
(10) Pub. No.: US 2008/0231029 A1
(43) Pub. Date: Sep. 25, 2008

(54) Tool support adapter for trailer hitch receiver

(76) Inventor: Lonnie L. Hummel, Sedalia, MO (US)

Correspondence Address: Donald W. Meeker;Patent Agent, 924 East Ocean Front #E, Newport Beach, CA, 92661, US

(21) Appl. No.: 11/726,970

(22) Filed: Mar. 22, 2007

(51) Int. Cl. B60R 9/06; B60R 11/00

(52) U.S. Cl. 280/769; 224/510

(57) ABSTRACT

The three piece tool support elbow bracket of the present invention breaks down into a horizontal arm, a vertical arm, and a horizontal platform. The three components adjustably interconnect and the horizontal arm connects to the trailer receiver hitch by a pin inserted through a hole in one component and into one of a series of spaced holes in the adjacent component. The horizontal platform comes in different replaceable sizes for different tools, so that each tool can stay attached to the properly sized horizontal platform and the platforms replaced on the vertical arm to change tools.

### CROSS-REFERENCE TO RELATED APPLICATIONS

Not Applicable.

### STATEMENT REGARDING FEDERALLY SPONSORED RESEARCH OR DEVELOPMENT

Not Applicable. THE NAMES OF THE PARTIES TO A JOINT RESEARCH OR DEVELOPMENT

Not Applicable.

### BACKGROUND OF THE INVENTION

1. Field of the Invention

The present invention relates to hitch-mounted accessories and particularly to an adjustable height and adjustable length adapter to attach a vise or other tool to a trailer hitch receiver on a truck wherein the tool adapter is formed as three piece elbow bracket which breaks down for storage having adjustable length horizontal bottom arm that is inserted into a hitch receiver and pinned in place, an adjustable height vertical arm pinned to the horizontal arm, and a horizontal platform pinned to the vertical arm by an adjustable length post for affixing a tool such as a vise or pipe threader, the platform being replaceable with different sizes for different tools.

2. Description of Related Art Including Information Disclosed Under 37 CFR 1.97 and 1.98

Workers and craftsmen who have need of their vehicles during the course of their work (e.g., contractors, electricians, plumbers, etc.) often need a sturdy tool mounting surface. Although pickup trucks and other truck-like vehicles have fold-down rear tailgates which may serve as a work surface, normal tailgates are not made for such use. Prior art devices fail to provide such a tool support adapter which is fully adjustable and breaks down for storage and has a removable replaceable platform for mounting different tools.

U.S. Pat. No. 6,511,088, issued Jan. 28, 2003 to Kahlstorf, is for a versatile trailer hitch mounting system which enables mounting of heavy duty equipment to existing trailer hitch hardware currently found on pickups, vans, SUV's, recreational vehicles, and automobiles. The type of heavy duty equipment that could be attached to the apparatus of the present invention would include a heavy duty table, a work station, a vise, a spool and/or a winch, and a level working surface.

U.S. Pat. No. D468,681, issued Jan. 14, 2003 to Rath, provides the ornamental design for an utility mount for use with trailer hitch receiver, which is shown with a vise being included solely for illustrative purposes.

U.S. Pat. No. D445,395, issued Jul. 24, 2001 to Okerlund, shows the ornamental design for a hitch mountable table.

U.S. Pat. No. 6,189,458, issued Feb. 20, 2001 to Rivera, claims a collapsible holder having a first end to be detachably connected to a conventional trailer hitch at the rear of a motor vehicle and a second end to be detachably coupled to a folding table. The collapsible holder has a pair of outer arms that are pivotally connected to opposite ends of a middle arm. When the collapsible holder is detached from the trailer hitch and uncoupled from the folding table, the outer and middle arms are adapted to be rotated into face to face alignment, with one arm located above the other, to form a compact package that is suitable for transport and storage between uses. In order to support an outdoor grille from the collapsible holder, an inner coupling post that is affixed to the grille is slidably received within and engaged by an outer coupling post that is affixed to the holder. In the alternative, the outdoor grille is coupled to the collapsible holder by a removable coupling attachment. The coupling attachment has a coupling post at one end thereof to carry the grille and a locking plate at the opposite end to be connected to the holder.

U.S. Pat. No. 7,090,104, issued Aug. 15, 2006 to Dorety, describes a combination table and support member assembly for use in connection with a trailer hitch mounted onto a vehicle, where the support member and table can be joined in various configurations to vary the table height when in use and to vary the lateral separation distance between the rear of the vehicle and the table and vertical components of the support member when in use or in transport to allow for sufficient distance to enable utilization of the tailgate, rear door or hatchback of the vehicle. Extension members may also be utilized to alter the configuration.

U.S. Pat. No. 6,082,269, issued Jul. 4, 2000 to Padberg, discloses a hitch-mountable table and umbrella assembly for support on a vehicle-mounted hitch. The assembly includes a base member with a horizontal component for releasable engagement with the hitch receiver tube of the hitch, and an upwardly extending vertical component. A first table and/or umbrella may be supported directly on the vertical component, and a second table may be rotatably mounted in vertically spaced relation above the first table when an adapter is used, with or without an umbrella.

U.S. Pat. No. 5,267,748, issued Dec. 7, 1993 to Curran, indicates a vehicle tool platform apparatus adapted for use with and attachment to a work type truck having a rear tailgate or a van with rear doors, said truck or van having a rear trailer hitch. A vehicle tool platform apparatus comprising a flat tool platform, elongated angle support bar having one end secured to the bottom surface of the tool platform and the other end adapted to be received and secured in the rear trailer hitch. A work tool, such as a vise, bench grinder or saw, is secured to the top surface of the tool platform. The angle and length of the support rod is designed so that the plane of the tool platform is at a height generally level with the floor of the van or the bed of the truck to which the work platform apparatus is to be secured. Further, the platform is positioned a sufficient distance from the rear of the vehicle to which the work platform is to be secured to permit the doors of the vehicle to be opened fully, or the tailgate of the truck to be lowered to a plane level with and adjacent to the top surface of the work platform apparatus.

U.S. Pat. No. D415,988, issued Nov. 2, 1999 to Stearns, puts forth the ornamental design for a tailgate extender.

U.S. Pat. No. 5,890,739, issued Apr. 6, 1999 to Cogswell, Sr., concerns a vertically adjustable hitch mounted vice. A vice mounted on a vehicle is provided including a vehicle with an adjustable vertical mounting mechanism coupled to a rear extent thereof. Further provided is a vice coupled to the adjustable vertical mounting mechanism.

U.S. Pat. No. 5,397,147, issued Mar. 14, 1995 to Ducharme, illustrates a vehicular work table apparatus comprising a vehicular work table apparatus coupleable to a hitch chassis of a vehicle. The table apparatus comprises a pedestal formed of a rod, the rod including a base end, a support end, and a intermediate location defined between the base end and the support end, the rod further including a support segment and a base segment, the support segment extending upwards from the intermediate location to the support end, the base segment extending from the intermediate location to the base end, the base end adapted to be coupled to a vehicle's hitch chassis to place the pedestal in an upright configuration. A plate coupled to the support end of the pedestal to define a table top, with the pedestal and table top defining a table. A means is provided for coupling the table to a vehicle to place the table in a stowed configuration.

U.S. Pat. No. 5,082,037, issued Jan. 21, 1992 to Hammons, is for an apparatus for mounting tools and other devices, which is capable of adjustment in both the vertical and horizontal directions relative to a box receiver mounted on the bumper of a vehicle. An L-shaped support section at its one end slidingly engages and is fixed to a box receiver mounted on a vehicle bumper. At its other end, L-shaped support section slidingly engages a second support member which has a mounting plate fixed thereto. The mounting plate is provided with a number of holes or elongated slots to provide means for mounting tools, motors, vises, and the like, to provide a secure mounting platform at remote locations, such as construction sites or campgrounds.

U.S. Pat. No. 7,063,311, issued Jun. 20, 2006 to Ascolese, provides a portable fiber optic workstation assembly including a base. A bracket is attached to and extends upwardly from the base. A post has a bottom end and an upper end. The bracket is adapted for releasably attaching the bottom end of the post to the base such that the post extends upwardly from the base. A frame has a front wall, a rear wall, a first lateral wall, a second lateral wall, a top surface and a bottom surface, a mesh screen is attached to and extending across an interior of the frame, the mesh screen is generally flush with the top surface. A hinge hingedly couples the frame to the post such that the bottom surface of the rear wall may be abutted against the upper end such that a plane of the frame is orientated generally perpendicular to a longitudinal axis of the post. The dive may alternately be hitch mounted.

U.S. Pat. No. 6,648,391, issued Nov. 18, 2003 to Whiteford, shows a truck bed extension device for use with a truck having a cargo bed structure, wherein the device allows for carrying items which extend beyond or overhang the bed structure. The device comprises a deck; a support structure; and a signaling system. The deck is horizontally adjustable relative to the bed structure so as to allow for achieving a desired spacing therebetween.

U.S. Pat. No. 4,705,254, issued Nov. 10, 1987 to Swanson, claims an adjustable and removable vice assembly for use on a vehicle comprising an elongated receiving member fixedly mountable on a rear end portion of a vehicle in generally parallel alignment with a longitudinal axis of the vehicle; an elongated support member receivable in the receiving member in rearwardly extending relationship therewith; and longitudinally slidably adjustable with respect thereto; a slide member which is vertically slidingly adjustable with respect to the elongated support member; a vice mounted on the slide member; and stabilizing and holding devices associated with the receiving member, the support member and the slide member for selectively stably holding the members in a selected fixed relationship.

U.S. Pat. No. 5,433,356, issued Jul. 18, 1995 to Russell, describes a vise having a fixed inner member with a stationary jaw and an elongate extension for inserting into and mounting to a trailer receiver attached to a motor vehicle, thus providing a vise for use in the field. The vise has a movable outer member and jaw operated by a threaded shaft and turned by a handle. The vise can be securely attached to receiver by a pin in one of four positions: upright, inverted, on its right side, on its left side.

Two U.S. Pat. No. 6,871,440 issued Mar. 29, 2005 and U.S. Pat. No. 6,684,550 issued Feb. 3, 2004 to Highfill, disclose a mounting system for a clay target thrower and rifle/pistol rest which comprises an L-shaped tube has a horizontal member that fits into a trailer hitch, and a vertical member. A platform is secured to a post that fits into the vertical member. The platform has bolt holes arranged to engage a variety of commercial clay target throwers and a gun/pistol rest. A threaded dowel is inserted through the a 180 degree horizontal slot in the vertical member, and screwed into a threaded hole in the post, thereby limiting the range the platform post can swivel within the vertical member. The dowel can be tightened to lock the post between zero and one-hundred-eighty degrees. A tension cable secures the vertical member to the vehicle to attenuate vibrations. A gun/pistol rest configured to mount from the platform has a forward cradle for a gun stock or barrel, and rear mount that variously functions as a rifle-butt cradle or a pistol-butt support.

U.S. Pat. No. 6,173,705, issued Jan. 16, 2001 to DeWitt, indicates a support device for attaching a trap shooter to a vehicle, particularly a pick-up truck in, which a frame is affixed to a conventional square receiver located below the bumper on the pick-up truck, the frame projecting away from the truck and upwardly, and terminating in a platform upon which the trap shooter is located. The platform is capable of rotation and its spacing from the tailgate can be controlled to allow easy access by an operator for easy loading of disks carried on the pick-up truck body.

U.S. Pat. No. D407,135, issued Mar. 23, 1999 to DeWitt, puts forth the ornamental design for a clay pigeon launcher support.

U.S. Pat. No. 4,576,395, issued Mar. 18, 1986 to Longoria, concerns a trailer hitch mounted tool support comprising an upstanding support which is open at its lower end for snug downward telescoping over an upwardly projecting hitch ball supported from a hitch tongue of a width greater than the diameter of the ball. The lower end of the upstanding support is downwardly abuttable against the upwardly facing surfaces of the hitch tongue spaced immediately outward of an upstanding cylindrical zone containing the outer periphery of the hitch ball and the support includes a plurality of circumferentially spaced clamp screws threadingly supported therefrom with the innermost ends of the clamp screws being clampingly engageable with the reduced diameter shank portion of the hitch ball spaced closely above the hitch tongue. The upper end of the upstanding support mounts a horizontal mounting plate therefrom which may be utilized to support a plurality of different objects such as a grinder, workbench, hoist, cycle carrier, sign, floodlight, pipe rack and the like.

U.S. Pat. No. 5,752,639, issued May 19, 1998 to Rice, illustrates a holding or carrying device that is mountable to a trailer hitch which comprises a support member having a horizontal portion that is removably attachable to the hitch, and a vertical portion that contains a tubular telescoping element. Attached to the upper end of the telescoping element is a carrying or holding element, such as a table, platform, or bracket. In one embodiment, the telescoping element is height-adjustable by means a plurality of opposed pairs of apertures in the telescoping element that are registrable with an opposed pair of apertures in the vertical portion, whereby a locking pin can be received in the opposed pair of apertures in the vertical portion, and a selected one of the opposed aperture pairs in the telescoping element. In another embodiment, a bicycle rack assembly is attached to the upper end of the telescoping element. The rack assembly comprises a rack member having a pair of support rods located and configured to support a bicycle frame, and a clamping member, operatively engageable with the rack member, that clamps the bicycle frame against the support rods.

U.S. Pat. No. 6,336,413, issued Jan. 8, 2002 to Ball, is for a tailgate table having a first arm, a second arm, and a table member. The first arm is configured for easy attachment to the existing trailer hitch receiver of a vehicle. The table member attaches to the second arm, which attaches to the first arm. The table member is configured with sidewalls and a bottom forming an interior. The interior may be compartmentalized. A top is hingedly attached to the table member to provide a substantially planar upper working surface when the top covers the interior.

What is needed is an adjustable height and adjustable length adapter to attach a vise or other tool to a trailer hitch receiver on a truck wherein the tool adapter is formed as three piece elbow bracket which breaks down for storage having adjustable length horizontal bottom arm that is inserted into a hitch receiver and pinned in place, an adjustable height vertical arm pinned to the horizontal arm, and a horizontal platform pinned to the vertical arm by an adjustable length post for affixing a tool such as a vise or pipe threader, the platform being replaceable with different sizes for different tools.

### BRIEF SUMMARY OF THE INVENTION

An object of the present invention is to provide an adjustable height and adjustable length adapter to attach a vise or other tool to a trailer hitch receiver on a truck wherein the tool adapter is formed as three piece elbow bracket which breaks down for storage having adjustable length horizontal bottom arm that is inserted into a hitch receiver and pinned in place, an adjustable height vertical arm pinned to the horizontal arm, and a horizontal platform pinned to the vertical arm by an adjustable length post for affixing a tool such as a vise or pipe threader, the platform being replaceable with different sizes for different tools.

In brief, the three piece tool support elbow bracket of the present invention breaks down into a horizontal arm, a vertical arm, and a horizontal platform. The three components adjustably interconnect and the horizontal arm connects to the trailer receiver hitch by a pin inserted through a hole in one component and into one of a series of spaced holes in the adjacent component. The horizontal platform comes in different replaceable sizes for different tools, so that each tool can stay attached to the properly sized horizontal platform and the platforms replaced on the vertical arm to change tools.

An advantage of the present invention is that it enables setting up a working tool on the back of a truck quickly and easily.

Another advantage of the present invention is that it collapses for storage to take up less room than when fully assembled for use.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the tool support adapter of the present invention mounted in a trailer hitch receiver of a truck;

FIG. 2 is a perspective view of the tool support adapter of FIG. 1 collapsed for storage;

FIG. 3 is an exploded perspective view of the different components of the tool support adapter.

### DETAILED DESCRIPTION OF THE INVENTION

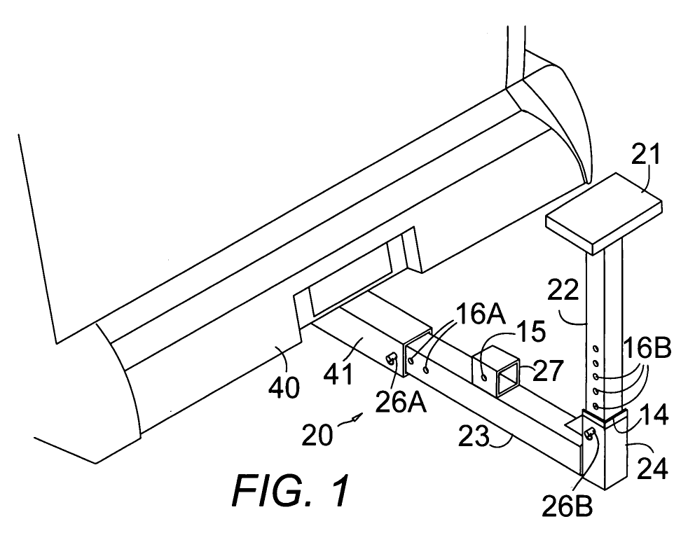

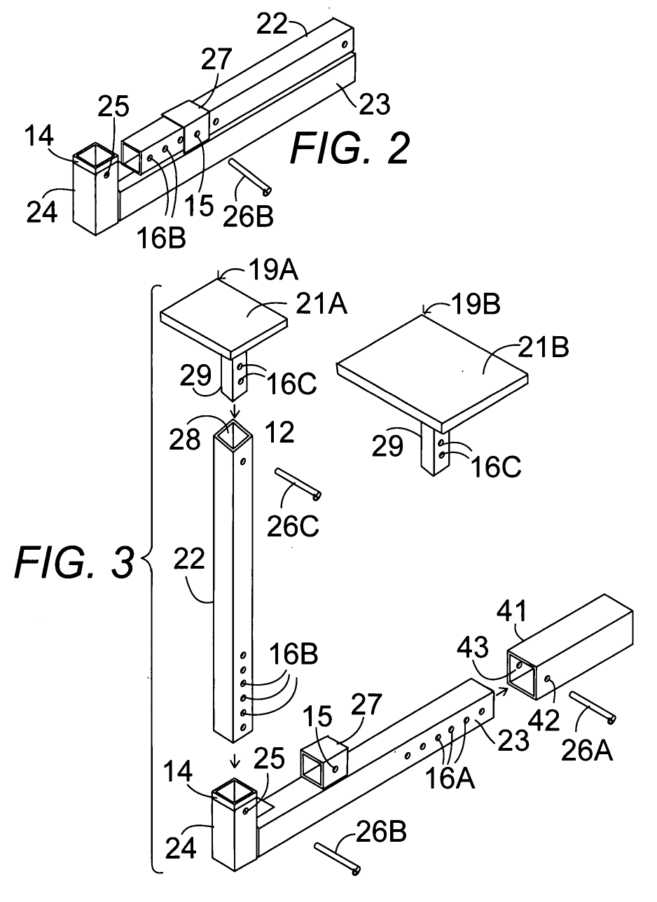

In FIGS. 1-3, an adjustable collapsible tool support adapter device comprises a three piece elbow bracket 20 which breaks down for storage, as shown in FIG. 2, and is inserted by a horizontal arm 23 in a trailer hitch receiver 41 of a vehicle 40, such as a truck so that a vertical arm 22 supporting a top platform 21 may be used to attach a tool, such as a vice or a pipe threading tool to the platform 21. A horizontal sleeve 27 secured to the bottom arm 23 receives the top arm 22 secured and pinned therein by the horizontal arm pin 26B so that all of the components are secured together for storage, as shown in FIG. 2.

The bottom horizontal arm 23 is removably inserted in an end opening 43 of the trailer hitch receiver 41 on the vehicle 40 and removably attached therein with the horizontal arm 23 protruding from the trailer hitch receiver by an adjustable amount to space an outer end of the horizontal arm away from the vehicle by an adjustable amount so that the outer end may be positioned close to the vehicle with a tailgate of the vehicle up or spaced beyond the outer edge of the tailgate with the tailgate down. The horizontal arm 23 has a vertical sleeve 24 adjacent to the outer end.

The horizontal arm 23 has a horizontal arm insertion portion on an inner end of the horizontal arm with a series of spaced holes 16A along the length of the horizontal arm insertion portion and the trailer receiver hitch 41 has at least one mating hitch hole 42 therein so that a removable hitch pin 26A is inserted through the hitch hole 42 into one of the horizontal arm holes 16A to removably secure the horizontal arm 23 within the trailer hitch receiver 41 by a desired adjustable length. The horizontal arm insertion portion further comprises an outer surface which mates with an inner surface of the trailer hitch receiver so that the horizontal arm 23 fits within the trailer hitch receiver 41 with a tight sliding fit.

The vertical arm 22 is inserted within the vertical sleeve 24 of the horizontal arm 23 and removably attached therein with the vertical arm 22 protruding above the horizontal arm 23 by an adjustable amount to space a top end of the vertical arm above the horizontal arm by an adjustable amount. The top end of the vertical arm 22 has a top end opening 28 therein.

The vertical arm 22 has a vertical arm insertion portion on a lower end of the vertical arm with a series of spaced holes 16B along the length of the vertical arm insertion portion and the horizontal arm 23 has at least one mating horizontal arm pin hole 25 communicating with the vertical sleeve 24 therein so that a removable horizontal arm pin 26B is inserted through the horizontal arm pin hole 25 into one of the vertical arm holes 16B to removably secure the vertical arm 22 within the vertical sleeve 24 of the horizontal arm 23 by a desired adjustable height. The vertical arm insertion portion further comprises an outer surface which mates with an inner surface of the vertical sleeve 24 in the horizontal arm 23 so that the vertical arm 22 fits within the vertical sleeve 24 with a tight sliding fit. The vertical sleeve has a reinforcing lip 14 around the top edge.

The horizontal platform 19 comprises a flat tool receiving surface 21 and a vertical post 29 extending downwardly therefrom. The vertical post 29 is inserted by an adjustable amount within the top end opening 28 in the vertical post 22 and removably attached therein with the horizontal platform 21 positioned above the vertical post by an adjustable amount so that the horizontal platform supports a tool attached thereto and so that the horizontal platform is removable from the vertical post and replaceable by a different horizontal platform 19A and 19B, shown in FIG. 3 with a different tool attached thereto, the tool receiving surfaces 21A and 21B being sized and structured to receive different tools attached thereto, such as a vice or a pipe threader.

The vertical post 29 of the horizontal platform 19 has a vertical post insertion portion on a lower end of the vertical post with a series of spaced holes 16C along the length of the vertical post insertion portion and the vertical arm 22 has at least one mating vertical arm pin hole 12 communicating with the top end opening 28 therein so that a removable vertical arm pin 26C is inserted through the vertical arm pin hole 12 into one of the vertical post holes 16C to removably secure the vertical post 29 within the vertical arm 22 by a desired adjustable height. The vertical post insertion portion further comprises an outer surface which mates with an inner surface of the top end opening 28 in the vertical arm 22 so that the vertical post 29 fits within the vertical arm 22 with a tight sliding fit.

The tool receiving surface 21, 21A and 21B of the horizontal platform 19, 19A and 19B is adjustable in height by adjusting the height of the vertical arm 22 to produce a comfortable height of the tool mounted on the horizontal platform and further adjustable in height by the height of the vertical post 29 in the vertical arm 22 so that each different tool can be positioned at a comfortable working height when the different horizontal platforms 19A and 19B are installed on the vertical arm 22.

It is understood that the preceding description is given merely by way of illustration and not in limitation of the invention and that various modifications may be made thereto without departing from the spirit of the invention as claimed.

What is claimed is:

1. An adjustable collapsible tool support adapter device for insertion in a trailer hitch receiver, the device comprising:
a three piece elbow bracket which breaks down for storage, the elbow bracket comprising:
a bottom horizontal arm removably inserted in a trailer hitch receiver on a vehicle and removably attached therein with the horizontal arm protruding from the trailer hitch receiver by an adjustable amount to space an outer end of the horizontal arm away from the vehicle by an adjustable amount, the horizontal arm having a vertical sleeve secured thereto adjacent to the outer end;
a vertical arm inserted within the vertical sleeve of the horizontal arm and removably attached therein with the vertical arm protruding above the horizontal arm by an adjustable amount to space a top end of the vertical arm above the horizontal arm by an adjustable amount, the top end having an opening therein;
a horizontal platform comprising a flat tool receiving surface and a vertical post extending downwardly therefrom, the vertical post inserted by an adjustable amount within the top end opening in the vertical post and removably attached therein with the horizontal platform positioned above the vertical post by an adjustable amount so that the horizontal platform supports a tool attached thereto and so that the horizontal platform is removable from the vertical post and replaceable by a different horizontal platform with a different tool attached thereto;
thereby forming an adjustable height and adjustable length collapsible adapter to attach a number of different tools to a trailer hitch receiver on a vehicle.

2. The device of claim 1 wherein the horizontal arm has a horizontal arm insertion portion on an inner end of the horizontal arm, the horizontal arm insertion portion having a series of spaced holes along the length of the horizontal arm insertion portion and the trailer receiver hitch has at least one mating hitch hole therein so that a removable hitch pin is inserted through the hitch hole into one of the horizontal arm holes to removably secure the horizontal arm within the trailer hitch receiver by a desired adjustable length.

3. The device of claim 2 wherein the horizontal arm insertion portion further comprises an outer surface which mates with an inner surface of the trailer hitch receiver so that the horizontal arm fits within the trailer hitch receiver with a tight sliding fit.

4. The device of claim 1 wherein the vertical arm has a vertical arm insertion portion on a lower end of the vertical arm, the vertical arm insertion portion having a series of spaced holes along the length of the vertical arm insertion portion and the horizontal arm has at least one mating horizontal arm pin hole communicating with the vertical sleeve attached thereto so that a removable horizontal arm pin is inserted through the horizontal arm pin hole into one of the vertical arm holes to removably secure the vertical arm within the vertical sleeve of the horizontal arm by a desired adjustable height.

5. The device of claim 4 wherein the vertical arm insertion portion further comprises an outer surface which mates with an inner surface of the vertical sleeve in the horizontal arm so that the vertical arm fits within the vertical sleeve with a tight sliding fit.

6. The device of claim 1 wherein the vertical post of the horizontal platform has a vertical post insertion portion on a lower end of the vertical post, the vertical post insertion portion having a series of spaced holes along the length of the vertical post insertion portion and the vertical arm has at least one mating vertical arm pin hole communicating with the top end opening therein so that a removable vertical arm pin is inserted through the vertical arm pin hole into one of the vertical post holes to removably secure the vertical post within the vertical arm by a desired adjustable height.

7. The device of claim 6 wherein the vertical post insertion portion further comprises an outer surface which mates with an inner surface of the top end opening in the vertical arm so that the vertical post fits within the vertical arm with a tight sliding fit.
